(19) United States
(12) Patent Application Publication
(10) Pub. No.: US 2017/0374053 A1
(43) Pub. Date: Dec. 28, 2017

(54) INFORMATION PROCESSING DEVICE, INFORMATION PROCESSING METHOD, COMPUTER READABLE STORAGE MEDIUM

(71) Applicant: FUJITSU LIMITED, Kawasaki-shi (JP)

(72) Inventor: KOICHI YASAKI, Kawasaki (JP)

(21) Appl. No.: 15/622,716

(22) Filed: Jun. 14, 2017

(30) Foreign Application Priority Data
Jun. 23, 2016 (JP) 2016-124437

(51) Int. Cl. H04L 29/06; G06F 3/0482

(52) U.S. Cl. CPC H04L 63/083; G06F 3/0482

(57) ABSTRACT

An information processing device including: a processor coupled to the memory and the processor configured to: in response to generation of an input screen displayed on a display by an application, obtain, for the displayed input screen, screen address information including at least a domain part among parts of the obtained screen address information, and screen structure information, in response to a determination that at least the domain part of the obtained screen address information and the obtained screen structure information of the displayed input screen respectively correspond to a stored domain part of screen address information and stored screen structure information among a plurality of stored screen address information and screen structure information, input the input information associated with the corresponding stored screen address information and stored screen structure information, to the displayed input screen for processing by the application.

### CROSS-REFERENCE TO RELATED APPLICATION

This application is based upon and claims the benefit of priority of the prior Japanese Patent Application No. 2016-124437, filed on Jun. 23, 2016, the entire contents of which are incorporated herein by reference.

### FIELD

The present embodiment relates to an information processing device, an information processing system, an information processing program, and an information processing method.

### BACKGROUND

User authentication is performed in one form or another when a cloud service is used. Many of the user authentications are based on passwords, and force work that is more complicated than ordinary character input, because a character string difficult to guess is input as a password. FIG. 1 is a diagram illustrating an example of key operations for inputting a password. FIG. 1 represents a case where a password “M$8ni3y0tmd@” is input on a software keyboard of an ordinary smart phone, and many key operations are needed because the changing of a character type or the like is needed.

As a function that frees a user from such complicated work, there is a function referred to as a password manager function (see, for example, Japanese Laid-open Patent Publication No. 2007-94903 or the like). This function automatically inputs an identification (ID) and a password registered in advance when key operation is to be started on a given screen for user authentication.

As forms of implementation of the password manager function in smart phones, there are a case where the password manager function is provided as an operating system (OS) function, a case where the password manager function is implemented within an application, and a case where the password manager function is implemented as a third (3rd) vendor application (3rd app). FIGS. 2A, 2B, and 2C are diagrams illustrating an example of password manager types. FIG. 2A represents the case where the password manager function is provided as an OS function. The OS function provides the password manager function to a given application (product examples: iOS keychain and WindowsHello). FIG. 2B represents the case where the password manager function is implemented within an application, and, for example, a browser provides the password manager function to a given Web application (product example: Chrome browser). FIG. 2C represents the case where the password manager function is implemented as a 3rd app, and the 3rd app granted a privilege provides the password manager function to a given application (product example: Lastpass).

In the case where the password manager function is provided as an OS function, the password manager function may support all applications, but does not support a multi-platform that provides same functions on a plurality of OSs. In the case where the password manager function is implemented within an application, for example, a case where the password manager function is implemented in a browser, the password manager function may support only Web applications, and is limited to particular browsers. It is thus difficult to implement the multi-platform. In the case where the password manager function is implemented as a 3rd app, the password manager function may support all applications, and it is easy to implement the multi-platform. The following description will therefore be made of the 3rd app type that supports all applications and which has the multi-platform capability.

FIG. 3 is a diagram illustrating an example of processing of a 3rd app. As illustrated in FIG. 3, operation of the 3rd app type includes, in the following order, (Step 1) checking whether a displayed screen is registered, (Step 2) identifying the position of a password box when the displayed screen is registered, and (Step 3) automatically inputting a registered password.

A screen information obtaining application program interface (API) is used to determine whether the screen currently displayed at a top in Step 1 is a registered password input screen. FIGS. 4A and 4B are diagrams illustrating an example of obtaining screen information. FIG. 4A illustrates a state in which the 3rd app obtains screen information from a Native app and a browser by a screen information obtaining API. As illustrated in FIG. 4B, a “uniform resource locator (URL)” is obtained as the screen information in the case of the browser app, and a “Pkgname name/Class name” is obtained as the screen information in the case of the Native app.

### SUMMARY

According to an aspect of the embodiment, an information processing device includes a memory to store a plurality of screen address information including at least a domain part among parts of the screen address information, and screen structure information, of a displayable input screen, in association with input information, and a processor coupled to the memory and the processor configured to: in response to generation of an input screen displayed on a display by an application, obtain, for the displayed input screen, screen address information including at least a domain part among parts of the obtained screen address information, and screen structure information, in response to a determination that at least the domain part of the obtained screen address information and the obtained screen structure information of the displayed input screen respectively correspond to a stored domain part of screen address information and stored screen structure information among the plurality of stored screen address information and screen structure information, input the input information associated with the corresponding stored screen address information and stored screen structure information, to the displayed input screen for processing by the application.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of key operations for inputting a password;

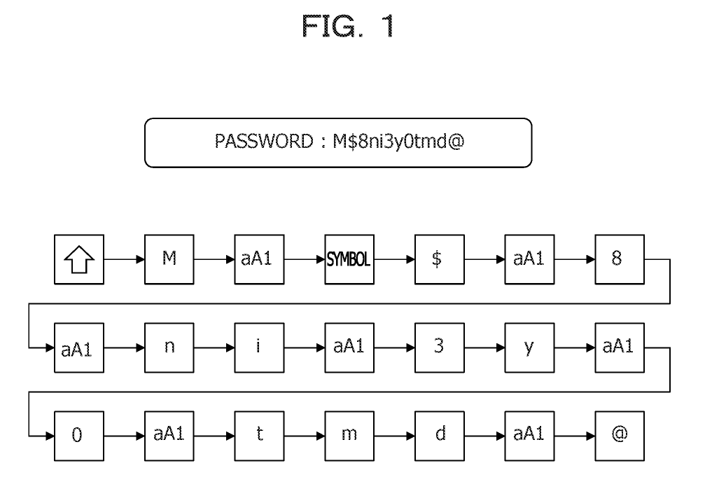

FIGS. 2A, 2B, and 2C are diagrams illustrating an example of password manager types;

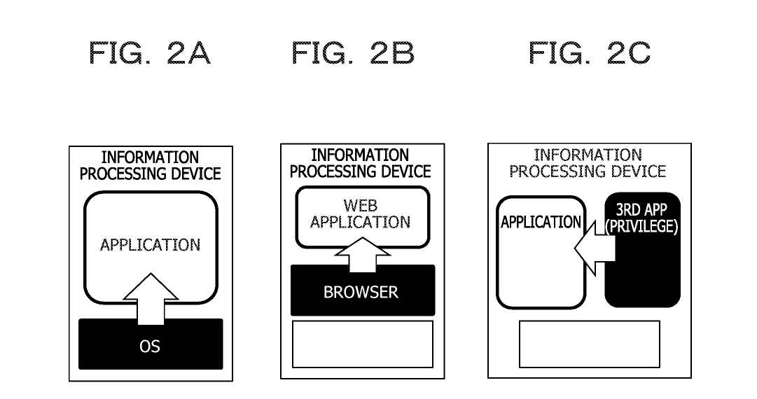

FIG. 3 is a diagram illustrating an example of processing of a 3rd app;

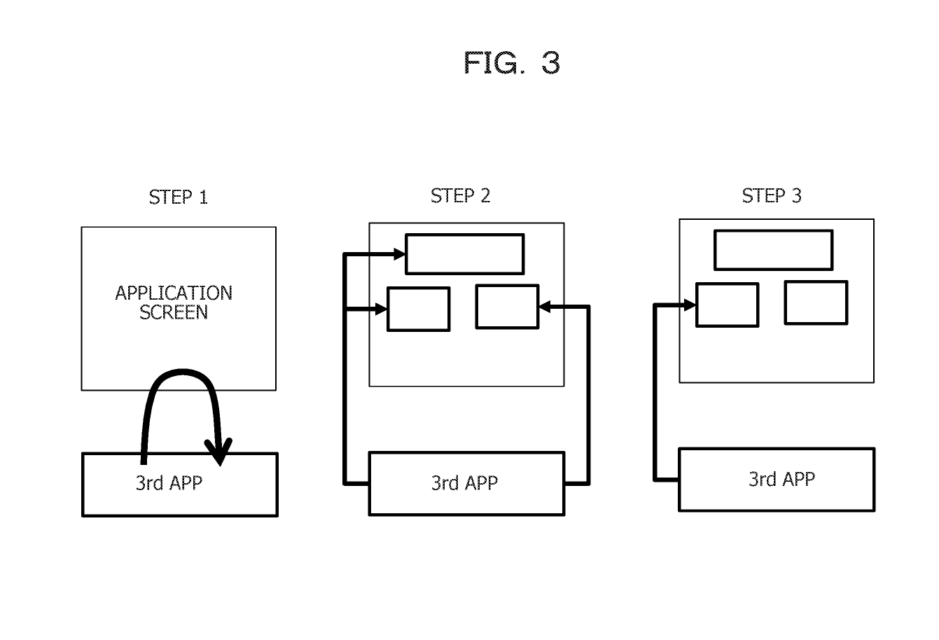

FIGS. 4A and 4B are diagrams illustrating an example of obtaining screen information;

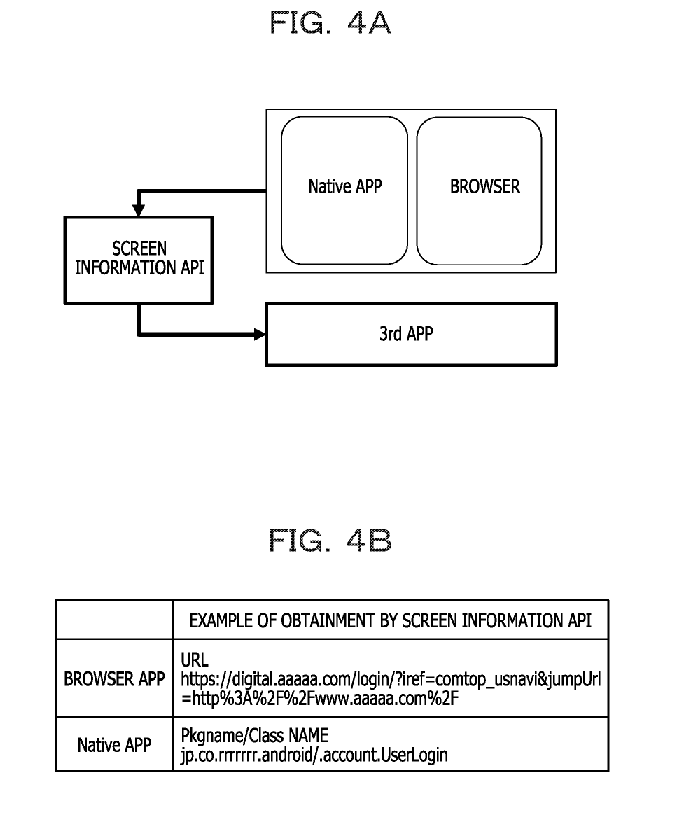

FIGS. 5A, 5B, and 5C are diagrams illustrating an example in which screen information changes;

FIG. 6 is a diagram illustrating an example of configuration of a system according to one embodiment;

FIG. 7 is a diagram illustrating an example of functional configuration of an information processing device;

FIG. 8 is a diagram illustrating an example of structure of a screen information and screen tree information database (DB);

FIGS. 9A and 9B are diagrams illustrating an example of screen tree information;

FIG. 10 is a diagram illustrating an example of structure of an authentication information DB;

FIG. 11 is a diagram illustrating an example of hardware configuration of an information processing device;

FIG. 12 is a flowchart illustrating an example of processing of the embodiment;

FIG. 13 is a diagram illustrating an example of a personal authentication screen;

FIG. 14 is a diagram illustrating a state in which an ID and a password are input automatically; and

FIG. 15 is a diagram illustrating an example of a service selecting screen.

### DESCRIPTION OF EMBODIMENT

As described above, the password manager function uses the screen information obtaining API to determine whether the display screen is a registered password input screen. However, there are cases where it is difficult to make correct determination because the URL obtained by the screen information obtaining API is altered.

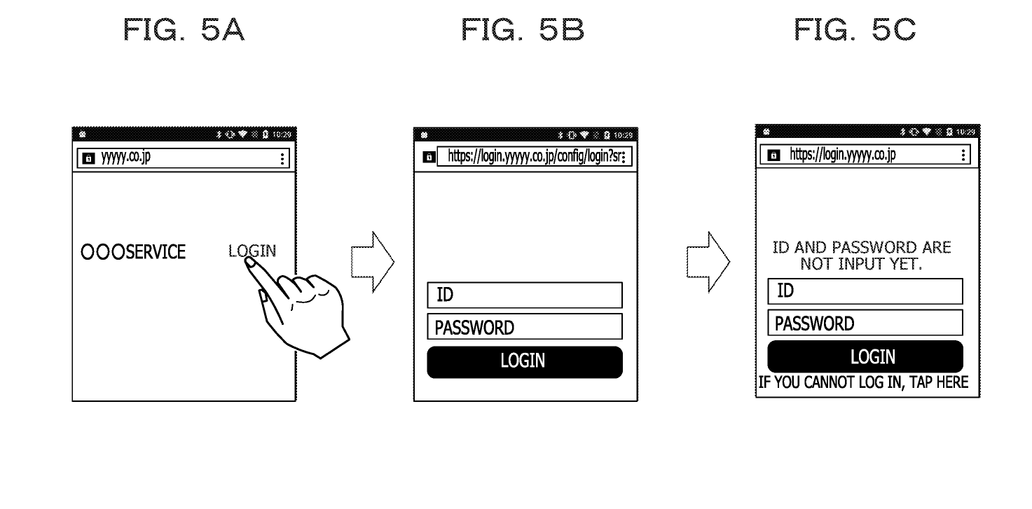

FIGS. 5A, 5B, and 5C are diagrams illustrating an example in which screen information changes. FIG. 5A illustrates a state in which a transition to a login screen of a certain service is selected. The selecting operation effects the transition to the login screen including an ID input field and a password input field as illustrated in FIG. 5B. In this case, a detailed URL is initially displayed in a URL display field in an upper portion of the screen. However, the smart phone may be provided with a function of changing the URL notation to display of only a domain name with the passage of time in order to display the URL notation to the user in a simple manner. FIG. 5C illustrates a state in which the URL displayed in the URL display field in the upper portion of the screen is abbreviated to only the domain name.

Therefore, page recognition may not be performed correctly depending on timing of registering screen information in advance or timing of obtaining screen information for automatic input. For example, the following case in which different services coexist in a same domain may be considered to be a case where the page recognition is not performed successfully. http://DomainA/ServiceA http://DomainA/ServiceB

In this case, when the URLs change to display of only the domain name both at a time of registration and at a time of automatic input, the URLs of Service A and Service B both become “http://DomainA/.” It is difficult for the password manager function to distinguish Service A and Service B from each other. There thus occurs a risk of incorrectly feeding an ID and a password for a service different from an actual target. In addition, in a case where one of a URL at a time of registration and a URL at a time of automatic input is in an abbreviated form, a service that is supposed to be a target service is recognized as a different service, and it is thus difficult to perform automatic input.

Accordingly, it is an object in one aspect of a mode of the disclosure to identify a screen correctly, and input correct information such as a password and the like.

Preferred embodiment will hereinafter be described.

<Configuration>

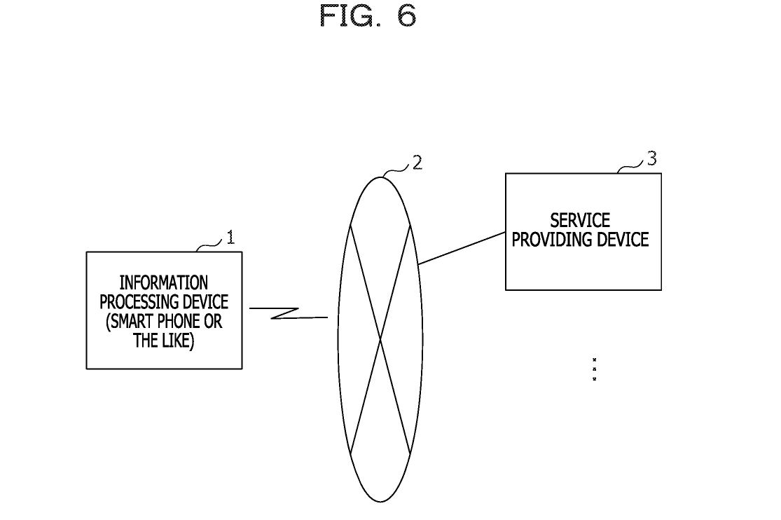

FIG. 6 is a diagram illustrating an example of configuration of a system according to one embodiment. In FIG. 6, an information processing device 1 such as a smart phone or the like couples to a service providing device 3 via a network 2 such as the Internet or the like. The service providing device 3 provides a given service in response to access from the information processing device 1 after password authentication is performed and the authentication succeeds.

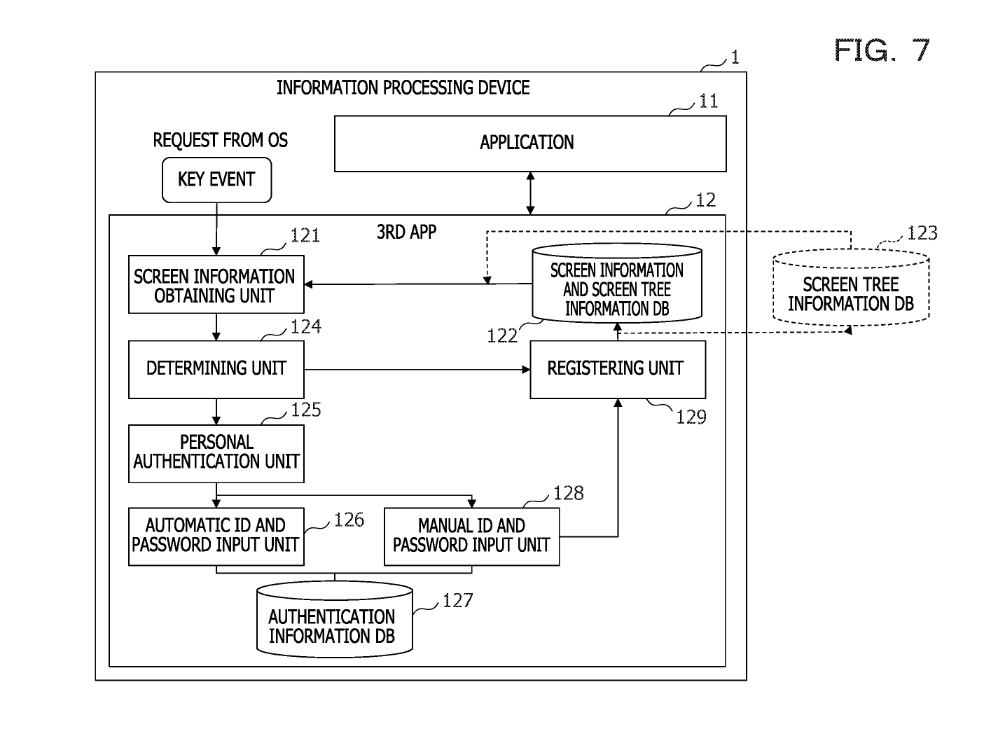

FIG. 7 is a diagram illustrating an example of functional configuration of an information processing device. The information processing device illustrated in FIG. 7 may be the information processing device 1 illustrated in FIG. 6. In FIG. 7, the information processing device 1 includes an arbitrary application 11 that necessitates password input for authentication and a 3rd app 12 of a 3rd vendor provision type, the 3rd app 12 providing a password manager function.

The 3rd app 12 includes a screen information obtaining unit 121, a screen information and screen tree information DB 122, a determining unit 124, a personal authentication unit 125, an automatic ID and password input unit 126, an authentication information DB 127, a manual ID and password input unit 128, and a registering unit 129.

The screen information obtaining unit 121 is started together with the 3rd app 12 when a higher-level OS detects a start of an operation of key input to an input field on a display screen (state in which a software keyboard is displayed by focusing on the input field) and issues a key event. The screen information obtaining unit 121 has a function of obtaining screen information (address information or the like) and screen tree information (part arrangement information) from the present display screen and obtaining same information from the screen information and screen tree information DB 122. Incidentally, the screen tree information in the screen information and screen tree information DB 122 may be retained in a screen tree information DB 123 disposed on a network outside the information processing device 1. This makes it possible to share the screen tree information, reduce cases where non-matching occurs by using latest screen tree information for subsequent determination, and reduce the trouble of manual input by a user. The screen information may also be managed outside. Incidentally, details of the screen information and screen tree information DB 122 and the screen tree information DB 123 will be described later.

The determining unit 124 has functions of comparing the screen information and the screen tree information of the present display screen, the screen information and the screen tree information being obtained by the screen information obtaining unit 121, with registered information in the screen information and screen tree information DB 122 or the like, and determining whether there is a match.

The personal authentication unit 125 has a function of authenticating the user of the information processing device 1 by calling a function of iris authentication or the like which function is possessed by the OS or the like.

The automatic ID and password input unit 126 has a function of automatically inputting an ID and a password registered in association with a registered screen in the authentication information DB 127 to input fields on the display screen when the screen information and the screen tree information of the present display screen match the registered information. Details of the authentication information DB 127 will be described later.

The manual ID and password input unit 128 has a function of receiving manual input of an ID and a password from the user when the screen information and the screen tree information of the present display screen do not match the registered information in the screen information and screen tree information DB 122 or the like.

The registering unit 129 has a function of updating information in the screen information and screen tree information DB 122 or the like when authentication succeeds, the authentication being based on the ID and the password manually input from the user by the manual ID and password input unit 128.

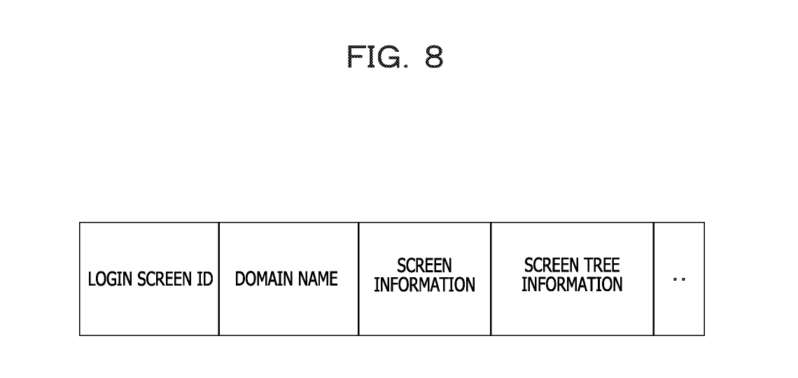

FIG. 8 is a diagram illustrating an example of structure of a screen information and screen tree information DB. The screen information and screen tree information DB illustrated by reference to FIG. 8 may be the screen information and screen tree information DB 122 illustrated in FIG. 7. The screen information and screen tree information DB 122 includes items such as “login screen ID,” “domain name,” “screen information,” “screen tree information,” and the like. The “login screen ID” is information identifying a login screen. The “domain name” is a domain part of screen address information of the login screen. The “Uniform Resource Locator (URL) of the screen address information” is the URL of the login screen. As this screen address information including the domain name and the URL, the screen address information of the display screen at a time of registration is set in advance. In order to support also a Native app, a Pkgname name and a Class name may also be set as the “screen address information” in place of the screen address information including the domain name and the URL. The “screen tree information” will be described in the following.

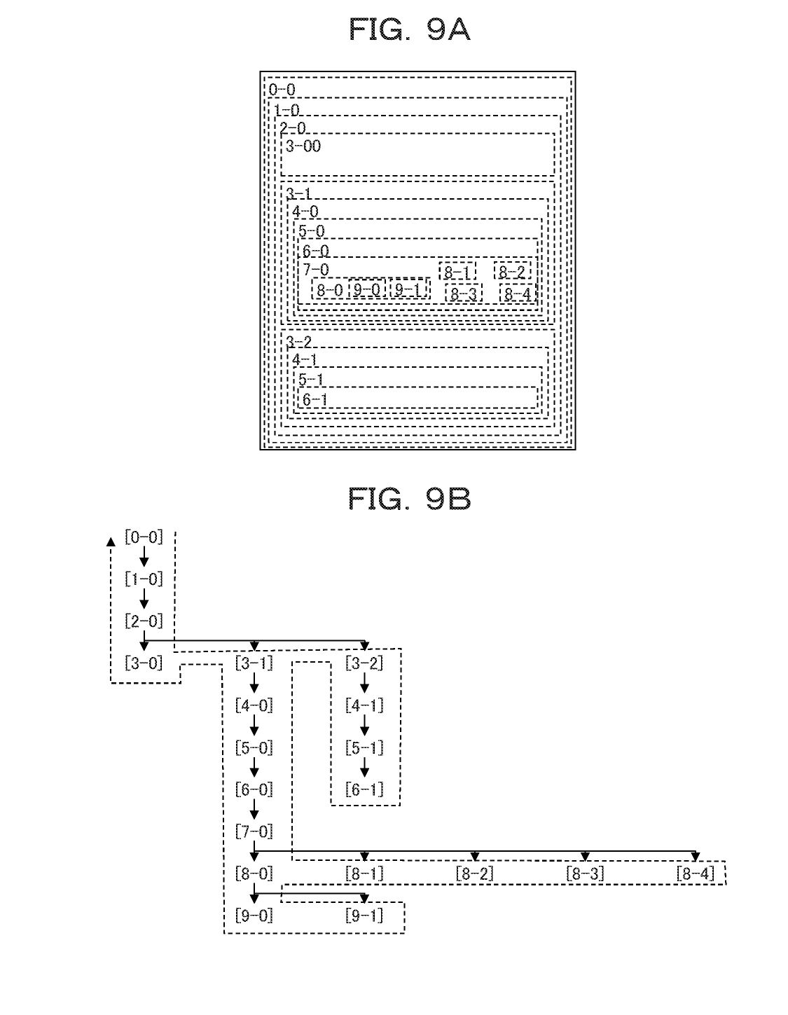

FIGS. 9A and 9B are diagrams illustrating an example of a screen tree information. FIG. 9A illustrates an example of arrangement of display parts (regions, text, buttons, and the like) on the display screen. FIG. 9B illustrates a hierarchical structure of the respective parts. Information about this hierarchical structure may be obtained from a browser or the like that draws (renders) the display screen. In the example of FIGS. 9A and 9B, parts [1-0] and [2-0] are arranged in series with each other in order on a part [0-0], and parts [3-0], [3-1], and [3-2] are arranged in parallel with each other on the part [2-0]. In addition, parts [4-0], [5-0], [6-0], and [7-0] are arranged in series with each other in order on the part [3-1], parts [8-0], [8-1], [8-2], [8-3], and [8-4] are arranged in parallel with each other on the part [7-0], and parts [9-0] and [9-1] are arranged in parallel with each other on the part [8-0]. In addition, parts [4-1], [5-1], and [6-1] are arranged in series with each other in order on the part [3-2]. Then, as indicated by a broken line in FIG. 9B, the screen tree information is obtained by listing (serializing) identifiers ([0-0] and the like) of the respective parts while tracing the hierarchical structure in order from the part as a root and going back to the root.

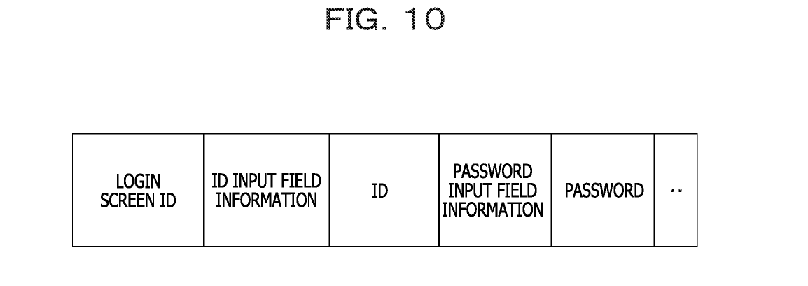

FIG. 10 is a diagram illustrating an example of structure of an authentication information DB. The authentication information DB illustrated by reference to FIG. 10 may be the authentication information DB 127 illustrated in FIG. 7. The authentication information DB 127 includes items such as “login screen ID,” “ID input field information,”“ID,”“password input field information,” “password,” and the like. The “login screen ID” is information identifying a login screen. The “ID input field information” is information identifying an ID input field. The “ID” is an ID registered in advance for automatic input (automatic feeding). The “password input field information” is information identifying a password input field. The “password” is a password registered in advance for automatic input (automatic feeding). In addition to the ID and the password, other information such as a bank account number or the like may be set as an object for automatic input.

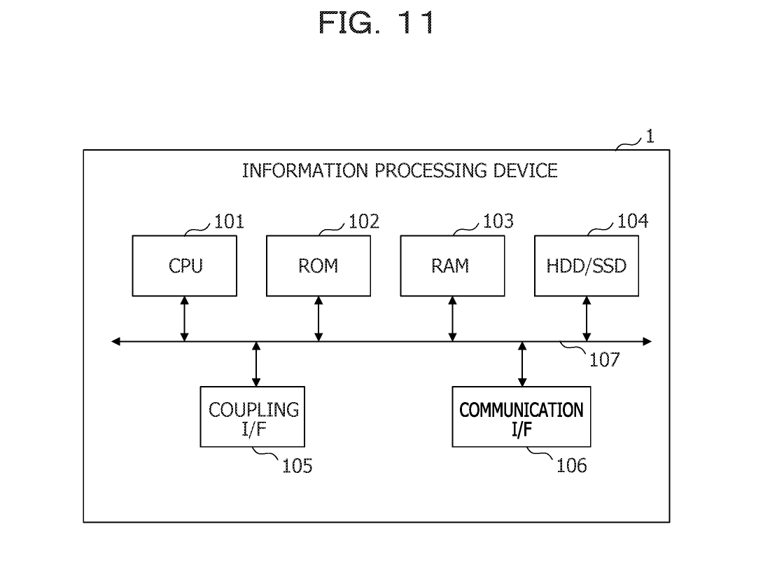

FIG. 11 is a diagram illustrating an example of hardware configuration of an information processing device. The information processing device illustrated in FIG. 11 may be the information processing device 1 illustrated in FIG. 6. In FIG. 11, the information processing device 1 includes a central processing unit (CPU) 101, a read only memory (ROM) 102, and a random access memory (RAM) 103 that are intercoupled via a bus 107. The information processing device 1 also includes a hard disk drive (HDD)/solid state drive (SSD) 104, a coupling interface (I/F) 105, and a communication I/F 106. The CPU 101 controls the operation of the information processing device 1 in a centralized manner by executing a program stored in the ROM 102, the HDD/SSD 104, or the like while using the RAM 103 as a work area. The coupling I/F 105 is an interface with equipment coupled to the information processing device 1. The communication I/F 106 is an interface for communicating with another information processing device via the network.

The functions of the information processing device 1 described with reference to FIG. 7 are implemented by executing a given program in the CPU 101. The program may be obtained via a recording medium, may be obtained via the network, or may be incorporated in the ROM. Data referred to and updated during processing is retained in the RAM 103 or the HDD/SSD 104.

<Operation>

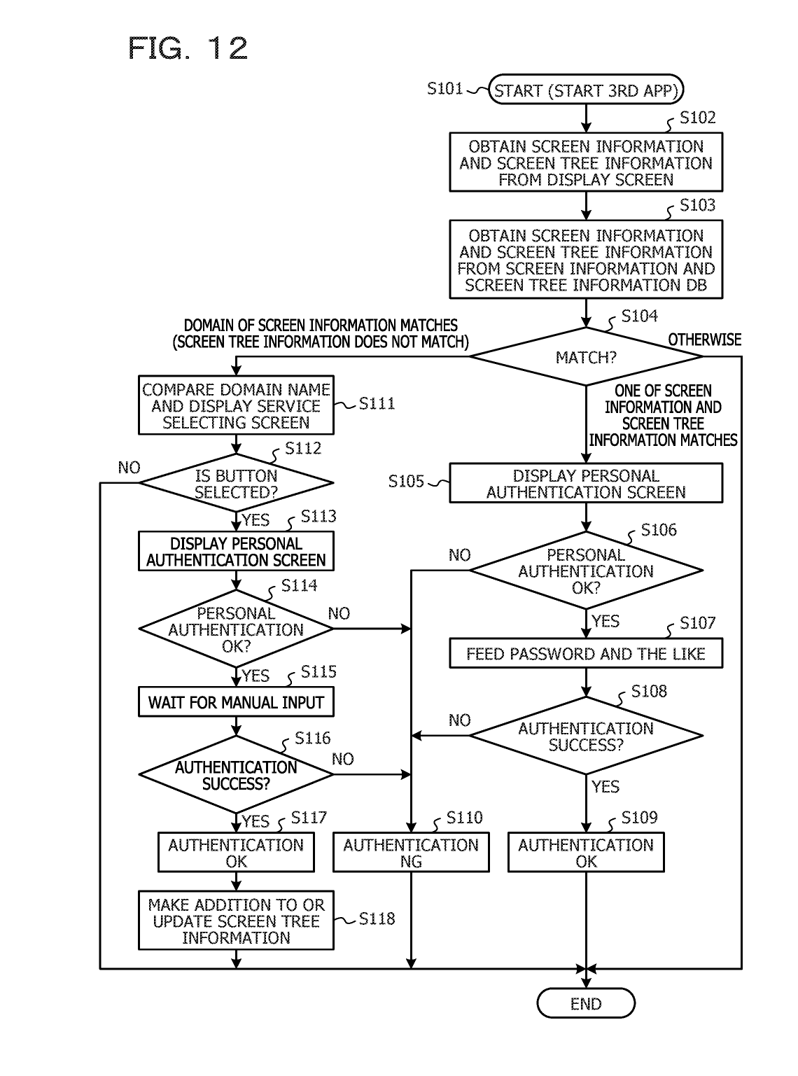

FIG. 12 is a flowchart illustrating an example of processing of the embodiment described above. In FIG. 12, the 3rd app 12 is started and starts processing when the higher-level OS detects a start of an operation of key input to an input field on the display screen and issues a key event (step S101).

First, the screen information obtaining unit 121 of the 3rd app 12 obtains screen information and screen tree information from the display screen (step S102), and obtains screen information and screen tree information from the screen information and screen tree information DB 122 (screen tree information DB 123) (step S103).

Next, the determining unit 124 compares a URL included in the screen information of the present display screen and the screen tree information, the screen information and the screen tree information being obtained by the screen information obtaining unit 121, with the registered information obtained from the screen information and screen tree information DB 122 or the like, and determines whether there is a match (step S104).

Here, when it is determined that the screen address information including the domain part and the URL matches perfectly (at least approximately perfectly or approximately identical), or a domain part of the URL matches and the screen tree information matches perfectly (at least approximately perfectly or approximately identical), it is determined that the present display screen is a registered screen. The identity of the screen may therefore be determined correctly even in a case where the URL display of the display screen is abbreviated with the passage of time (FIG. 5).

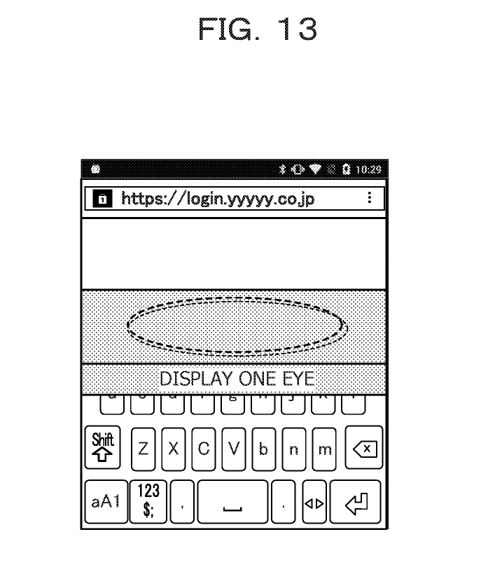

Next, the personal authentication unit 125 displays a personal authentication screen by calling the function of iris authentication or the like which function is possessed by the OS or the like (step S105). FIG. 13 is a diagram illustrating an example of a personal authentication screen. A camera photographed image is displayed on the screen, and guidance is performed so that one eye is photographed within an elliptical frame. When the one eye is photographed within the elliptical frame, authentication is performed based on iris feature information registered within the information processing device 1.

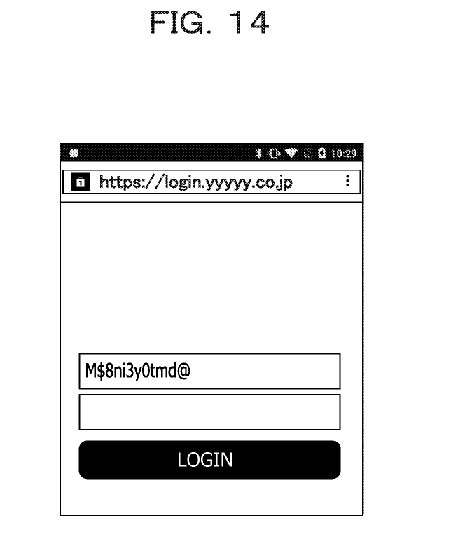

Returning to FIG. 12, when the personal authentication succeeds (YES in step S106), the automatic ID and password input unit 126 automatically inputs (feeds) an ID and a password registered in association with the registered screen (login screen) in the authentication information DB 127 into input fields on the display screen (step S107). FIG. 14 illustrates a state in which an ID and a password are automatically input into an ID input field and a password input field of a login screen.

Returning to FIG. 12, when authentication based on the automatically input password and the like succeeds (YES in step S108), authentication OK (step S109) is recognized. The processing is then ended. When the personal authentication does not succeed (NO in step S106) or the authentication does not succeed (NO in step S108), authentication NG (step S110) is recognized. The processing is then ended.

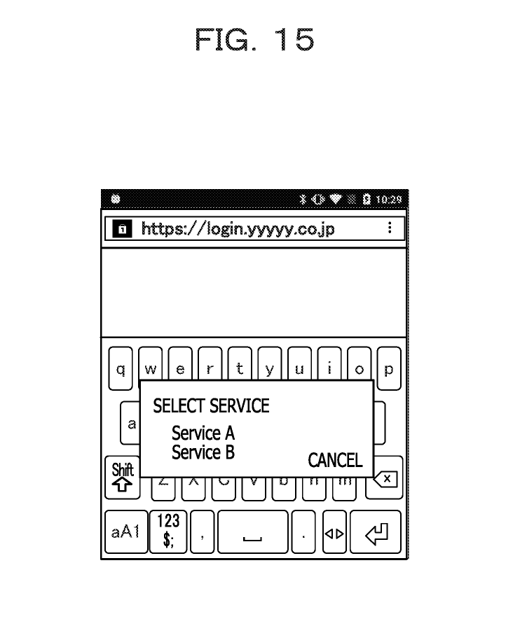

On the other hand, when the screen tree information does not match but the domain of the screen information matches in the comparison of the screen information and the screen tree information of the present display screen with the registered information (step S104), the manual ID and password input unit 128 displays a service selecting screen (step S111). For example, the manual ID and password input unit 128 extracts services having a common domain name by comparing the matching domain with the registered information in the screen information and screen tree information DB 122, generates a service selecting screen by listing the services in a form of buttons, and displays the service selecting screen. FIG. 15 is a diagram illustrating an example of a service selecting screen, which requests selection from “Service A” and “Service B.” A canceling button is also provided which is selected when neither of the services is desired, for example.

Returning to FIG. 12, when cancellation is selected without selection being made from the service candidate buttons in the list on the service selecting screen (NO in step S112), the 3rd app 12 ends the processing.

When a service candidate button in the list is selected (YES in step S112), the personal authentication unit 125 displays a personal authentication screen by calling the function of iris authentication or the like which function is possessed by the OS or the like (step S113). The personal authentication screen is similar to that illustrated in FIG. 13.

In FIG. 12, when the personal authentication succeeds (YES in step S114), the manual ID and password input unit 128 receives an ID and a password manually input from the user (step S115).

When authentication based on the manually input password and the like thereafter succeeds (YES in step S116), authentication OK (step S117) is recognized. Next, the registering unit 129 makes an addition to or updates the screen tree information in the screen information and screen tree information DB 122 or the screen tree information DB 123 (step S118). The processing is then ended. As a result of making the addition to or updating the screen tree information, screen tree information matches and thus automatic input is possible at a next time of login to the same service.

When the personal authentication does not succeed (NO in step S114) or the authentication does not succeed (NO in step S116), authentication NG (step S110) is recognized. The processing is then ended. When neither the domain of the screen information nor the screen tree information matches, the processing is ended. In this case, the user manually inputs an ID and a password.

<Review>

As described above, according to the present embodiment, it is possible to identify a screen correctly, and input correct information such as a password or the like.

Preferred embodiment has been described above. The above description has been made by illustrating specific concrete examples. It is apparent, however, that various modifications and changes may be made to these concrete examples without departing from the wide spirit and scope defined in claims. For example, details of the concrete examples and the accompanying drawings are not to be construed as restrictive.

The screen information obtaining unit 121 is an example of “obtaining unit.” The determining unit 124 is an example of “determining unit.” The automatic ID and password input unit 126 is an example of “inputting unit.”

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a memory to store a plurality of screen address information including at least a domain part among parts of the screen address information, and screen structure information, of a displayable input screen, in association with input information; and
a processor coupled to the memory and the processor configured to:
in response to generation of an input screen displayed on a display by an application, obtain, for the displayed input screen, screen address information including at least a domain part among parts of the obtained screen address information, and screen structure information;
in response to a determination that at least the domain part of the obtained screen address information and the obtained screen structure information of the displayed input screen respectively correspond to a stored domain part of screen address information and stored screen structure information among the plurality of stored screen address information and screen structure information, input the input information associated with the corresponding stored screen address information and stored screen structure information, to the displayed input screen for processing by the application.

2. The information processing device according to claim 1, wherein in response to the determination that approximately all the parts of the obtained screen address information correspond to approximately all parts of a stored domain part of screen address information and stored screen structure information among the plurality of stored screen address information and screen structure information, input the input information associated with the corresponding stored screen address information and stored screen structure information to the input screen for processing by the application.

3. The information processing device according to claim 1, wherein in response to the determination that the obtained screen structure information does not correspond to the stored screen structure information, wait for input into the displayed input screen.

4. The information processing device according to claim 3, wherein to wait for the input into the displayed input screen, the processor is further configured to:
display a selectable list of stored service names among the stored plurality of screen address information that include at least a domain part corresponding to the obtained domain part of the screen address information, and
in response to the processing of the input information by the application based on a selection from the selectable list, update the stored screen structure information of the displayed input screen corresponding to the selected service name.

5. The information processing device according to claim 1, wherein the screen structure information is information obtained by listing identifiers of display parts of the displayed input screen displayed on the display along with a hierarchical structure of the display parts.

6. The information processing device according to claim 3, wherein the screen address information and the screen structure information of the displayed input screen is obtained from the application rendering the displayed input screen on the display.

7. The information processing device according to claim 3, wherein the input information is authentication information.

8. The information processing device according to claim 1, wherein the parts of the screen address information include at least a domain name as the domain part and a uniform resource location (URL) information.

9. An information processing method comprising:
storing a plurality of screen address information including at least a domain part among parts of the screen address information, and screen structure information, of a displayable input screen, in association with input information;
in response to generation of an input screen displayed on a display by an application, obtaining, for the displayed input screen, screen address information including at least a domain part among parts of the obtained screen address information, and screen structure information; and
in response to a determination that at least the domain part of the obtained screen address information and the obtained screen structure information of the displayed input screen respectively correspond to a stored domain part of screen address information and stored screen structure information among the plurality of stored screen address information and screen structure information, inputting the input information associated with the corresponding stored screen address information and stored screen structure information, to the displayed input screen for processing by the application.

10. A non-transitory computer-readable medium storing executable instructions, which when executed by a computer, cause the computer to perform a process comprising:
storing a plurality of screen address information including at least a domain part among parts of the screen address information, and screen structure information, of a displayable input screen, in association with input information;
in response to generation of an input screen displayed on a display by an application, obtaining, for the displayed input screen, screen address information including at least a domain part among parts of the obtained screen address information, and screen structure information; and
in response to a determination that at least the domain part of the obtained screen address information and the obtained screen structure information of the displayed input screen respectively correspond to a stored domain part of screen address information and stored screen structure information among the plurality of stored screen address information and screen structure information, inputting the input information associated with the corresponding stored screen address information and stored screen structure information, to the displayed input screen for processing by the application.
